(19) United States
(12) Patent Application Publication
(10) Pub. No.: US 2015/0040069 A1
(43) Pub. Date: Feb. 5, 2015

(54) USER INTERFACE FOR TRACKING HEALTH BEHAVIORS

(71) Applicant: Oracle International Corporation, Redwood Shores, CA (US)

(72) Inventors: Vasanthan GUNARATNAM, San Jose, CA (US); Victor MATSKIV, Walnut Creek, CA (US); Divya SHAH, Sunnyvale, CA (US); Alex TAM, San Francisco, CA (US); Philip FOECKLER, Richmond, CA (US)

(21) Appl. No.: 13/955,331

(22) Filed: Jul. 31, 2013

(51) Int. Cl. G06F 3/0482; G06F 3/0486; G06F 3/0481

(52) U.S. Cl. CPC G06F 3/0482; G06F 3/04817; G06F 3/0486
USPC 715/834

(57) ABSTRACT

Systems, methods, and other embodiments associated with a user interface for tracking behaviors are described. In one embodiment, a method includes generating, on a display of a computing device, a graphical user interface (GUI). The GUI includes a dial that indicates a chronological order for a set of events. The dial includes a center area with an activity object for manipulating the set of events. The GUI includes a context panel with one or more buttons for modifying the set of events. The method includes populating the dial with icons for the set of events by pinning the icons to the dial. The set of events include predefined events for tracking behaviors of a user. Populating the dial includes displaying the icons around the dial to correlate with when each of the set of events occurs.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Consistently tracking behaviors and ensuring an individual follows a schedule can be an important, yet difficult task. This is especially true in the context of medical behaviors (e.g., taking medication, tracking water/food intake, and so on) since missing doses of medication or logging other medical related activities can be critical to an individual's health. However, existing approaches that remind an individual when to take a medication or that are used to log information about the individual's activities suffer from several difficulties. For example, often a several step process that includes multiple menus and clicks to change when a dosage of medication is to be taken or to log when it was taken is necessary. This complexity results in a loss of context on a display that can confuse a user and complicate use of a device.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a device associated with generating a graphical user interface for tracking behaviors.

FIG. 2 illustrates one embodiment of a graphical user interface for tracking behaviors.

FIG. 3 illustrates one embodiment of a graphical user interface for tracking behaviors.

FIG. 4 illustrates one embodiment of a graphical user interface for tracking behaviors.

FIG. 5 illustrates one embodiment of a graphical user interface for tracking behaviors.

FIG. 6 illustrates one embodiment of a graphical user interface for tracking behaviors.

FIG. 7 illustrates one embodiment of a graphical user interface for tracking behaviors.

FIG. 8 illustrates one embodiment of a graphical user interface for tracking behaviors.

FIG. 9 illustrates one embodiment of a graphical user interface for tracking behaviors.

FIGS. 10A and 10B illustrate two separate embodiments of a graphical user interface for tracking behaviors.

FIGS. 11A and 11B illustrate two separate embodiments of a graphical user interface for tracking behaviors.

FIG. 12 illustrates one embodiment of a method associated with generating a graphical user interface for tracking behaviors.

FIG. 13 illustrates an embodiment of a computing system in which example systems and methods, and equivalents, may operate.

### DETAILED DESCRIPTION

Systems, methods and other embodiments are described herein that are associated with a user interface for tracking behaviors. For example, consider a user that has a complex schedule of different medications and doses for those medications. As another example, consider that the user may need to track consumption of water/food or track a sleep schedule for a day. Traditionally, the user may have manually tracked behaviors, such as when medication was taken by using a spreadsheet application or other manual method. However, using a spreadsheet or other manual method generally requires the user to remember when a behavior is due (e.g., when to take a dose of medicine) and to log the behavior on a schedule. Additionally, using a spreadsheet schedule does not provide for flexibility to easily change the events in the schedule, a format of the schedule or to easily report logged activity. Accordingly, in one embodiment, systems, methods and other embodiments for implementing a user interface to provide tracking and logging of behaviors is provided.

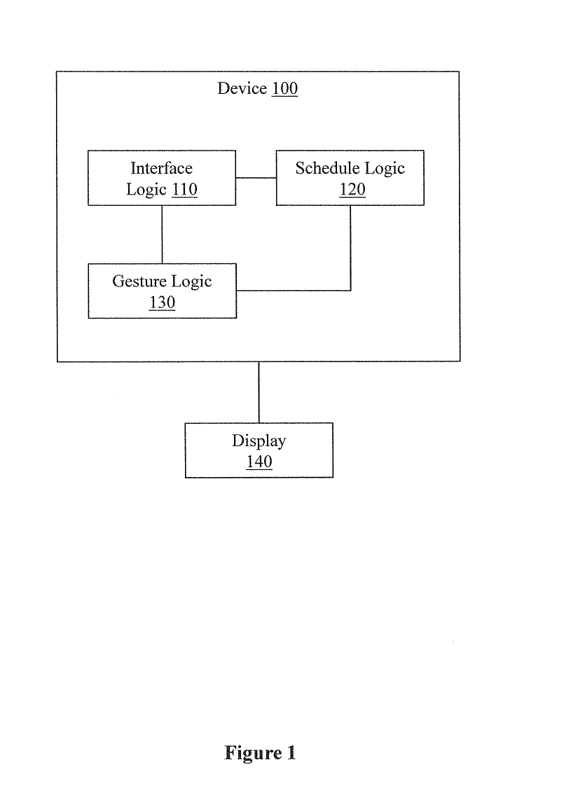

With reference to FIG. 1, one embodiment of a device 100 associated with a user interface for tracking behaviors of a user is illustrated. The device 100 is an electronic device, such as a smartphone, tablet or other portable electronic/computing device that includes at least a processor and that is capable of generating and displaying a user interface and executing applications. The device 100 includes interface logic 110, schedule logic 120, and gesture logic 130. The device 100 is, for example, connected to a display 140 and is configured to render a user interface on the display 140. In one embodiment, the display 140 is integrated with the device 100, while in another embodiment, the display 140 is separate from the device 100 but operably connected to the device 100 so that the device 100 can control the display 140.

Additionally, the interface logic 110 is configured to generate a graphical user interface (GUI) for viewing and interaction by a user on the display 140. For example, the interface logic 110 generates (i.e., renders on the display 140) the GUI to provide a user with a way to interact with the device 100 for tracking and logging information about medical behaviors (e.g., medication, sleep cycles, and so on). That is, the GUI provides an interface to a user for viewing, editing, and generally interacting with a schedule of events and/or progress of an activity so that the user can accurately maintain the schedule and/or log details of the activity.

Furthermore, the schedule logic 120 is configured to maintain a set of events (i.e., a schedule of behaviors/activities) and to populate the GUI with the set of events. For example, the schedule logic 120 populates the GUI with the set of events by rendering icons that represent the set of events on the GUI or by providing the events to the interface logic 110 for rendering on the GUI. In either case, the device 100 renders the set of events as icons that are pinned to a dial of the GUI, which will be described in greater detail below.

In one embodiment, the schedule logic 120 is configured to retrieve one or more events from a third party service or application that is remote to the device 100. For example, the schedule logic 120 may retrieve events from a server or other location and display the events on the GUI. Additionally, events may be added directly to the GUI by a user. In one embodiment, the gesture logic 130 monitors the GUI for input from a user. The gesture logic 130 is configured to detect gestures on the display 140 and translate the gestures into inputs. Accordingly, the display 140 is a touch sensitive display. Alternatively, in another embodiment, the display 140 is not touch sensitive and gestures are provided to the GUI by a user via a mouse or other input tool.

In general, the gestures may include gestures for adding, modifying, and performing other actions in relation to events displayed on the GUI. The gesture logic 130 determines the gestures according to a location of the gestures on the display 140 in relation to elements of the GUI. In this way, a user can provide input to the GUI without using many different menus and while maintaining a context of the GUI.

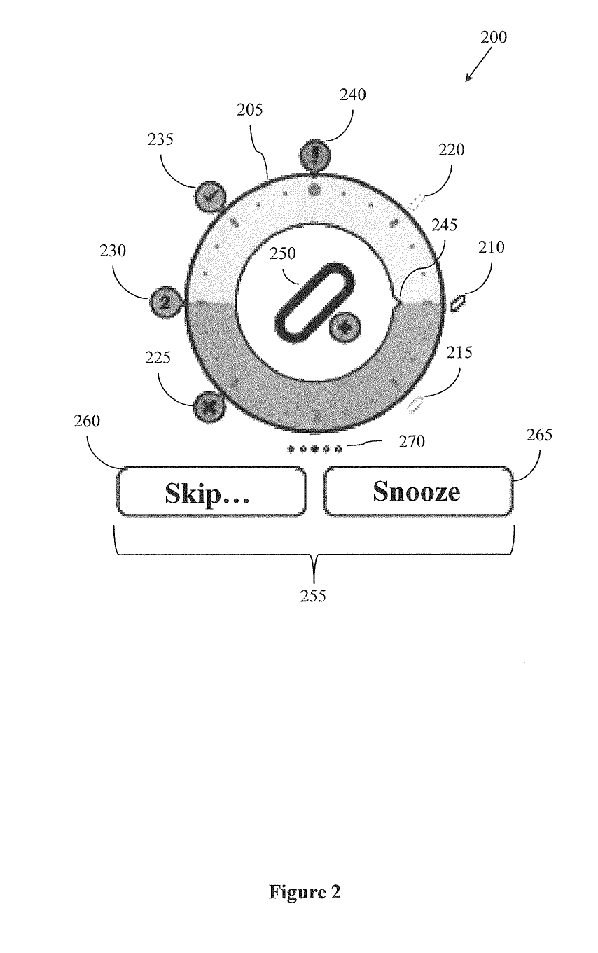

For example, in one embodiment, the interface logic 110 generates the GUI with a dial, an activity object within a center area of the dial, and a context panel that includes one or more buttons below the dial. One example is shown in FIG. 2. Consequently, the GUI does not include multiple sets of menus and screens for interacting with events displayed on the GUI. Instead, the gesture logic 130 is configured to detect gestures in relation to the dial, the activity object, and the context panel in order to maintain a context of the GUI.

In one embodiment, the dial includes indicators of time for displaying a clock like schedule for the set of events. When displaying time, the dial includes a twenty-four hour period of time that correlates with one day. Accordingly, the dial provides an overview of scheduled events (e.g., medication doses) for the day. Alternatively, the dial includes indicators of an amount (e.g., time of day or amount of water consumed) for displaying a quantitative goal. If the dial is generated for tracking quantity (e.g., amount of water consumed) then the dial displays increments that correlate with each unit consumed toward the quantitative goal.

By way of illustration consider FIG. 2. FIG. 2 illustrates one example of a GUI 200 generated by the interface logic 110. The GUI 200 includes a dial 205 that displays chronological indicators of time for a given day. In one embodiment, the dial 205 graphically rotates as time progresses, or, alternatively, a clock hand or other displayed indicator rotates around the dial 205 as time progresses to specify a current time. Furthermore, the dial 205 includes indicators for an entire twenty four hour period of a day and not only a twelve hour period of time as with a traditional clock. In this way, the dial 205 displays information about a behavior of a user for a whole day in a single view (e.g., shows scheduled and logged medication doses).

By displaying the whole day in a single view, the GUI 200 provides an overview of a schedule for the whole day. Accordingly, a user can view events in a single context that is not cluttered or obscured by irrelevant information (e.g., additional schedules for other behaviors). As used in this disclosure, the term context generally refers to a subject (e.g., medical behavior, medication doses, consumption tracking, and so on) of the GUI 200 and relevant aspects associated with the subject. Thus, consistently maintaining a view of the GUI 200 without a presence of additional menus, windows, or screens is referred to as maintaining a context of the GUI 200. Consequently, the context provides a user of the GUI 200 with a complete set of relevant information for interacting with and viewing a schedule of the set of events on the GUI 200.

Maintaining the context of the GUI 200 also occurs through providing tools for interacting with the GUI 200 in the single view. That is, a user controls and modifies events on the GUI 200 through the single view and without navigating additional menus or screens.

With continued reference to FIGS. 1 and 2, the schedule logic 120 of FIG. 1 is configured to populate the dial 205 of FIG. 2 with a set of events that correlate with logged and/or scheduled behaviors for the user. For example, the dial 205, in FIG. 2, is shown with events 210-240. The events 210-240 are pinned to the dial 205 at locations that correlate with a time at which each of the events 210-240 will occur, should have occurred, or have occurred. On the dial 205, event 210 is a next event that is to occur as indicated by a current time indicator 245. Accordingly, events 210 and 215 are yet to occur and are therefore displayed as a graphic of a pill which correlates with a behavior (i.e., medication doses) associated with the GUI 200. Of course, for other behaviors, a graphic displayed for each event correlates with the behavior (e.g., food, water, exercise, mood, and so on).

Additionally, in one embodiment, when an event is due, the schedule logic 120 generates an alert to inform a user to perform a correlating behavior (e.g., take medication). In addition to generating an alert that a current event is due, the schedule logic 120 may also provide further information about the event with the alert. For example, when the event is a medication dose, information about the dose is also displayed. In one embodiment, the information includes a name of a medication, a dose amount, whether the dose is to be taken with food/water, and so on.

Events 220-240 are events that have already occurred or that should have occurred. Event 220 is an example of a medication dose that was originally due at an associated time shown on the dial 205 but was not logged. For example, a user skipped, snoozed, or ignored the event 220. Accordingly, the event 220 is represented by a dashed pill shape on the dial 205 since event 220 was not logged at the indicated time when it was originally scheduled. Event 225 illustrates another example of how the interface logic 110 may animate an icon for an event that the user skipped. That is, upon the user tapping the skip button 260 when the event 225 was due, an icon for the event 225 is changed from a pill into an “X” bubble as now shown.

Event 230 is an example of an event where multiple behaviors were logged for the same time. That is, for example, multiple medications where taken together or, more generally, two events occurred simultaneously and were logged successfully. Thus, an icon for the event 230 indicates a “2” to denote that two events occurred together and were both successfully logged. Event 235 is a single event that was logged successfully when it occurred. Accordingly, the even 235 is now represented by a check mark to denote successful completion. Event 240 is an event that is overdue and has not been logged or otherwise acknowledge. Accordingly, an icon for the event 240 is displayed with an exclamation mark to indicate that the event 240 did not occur as planned/scheduled and has not been addressed by the user.

In addition to displaying different shapes of icons and icons with different text/symbols, the interface logic 110 is configured to generate icons for events with different colors and/or shapes to denote different conditions associated with an occurrence of an event. That is, for example, the interface logic 110 generates a red icon for the event 240 since the event 240 was not logged. Likewise, the interface logic 110 generates a yellow icon for a skipped event (e.g., event 225). The interface logic 110 generates icons for events that have been logged successfully in a green color (e.g., 230-235) or other color that commonly denotes a positive condition. Accordingly, the interface logic 110 renders icons for the events as a function of a current state/condition of the events.

Continuing with the GUI 200, the interface logic 110 renders an activity object 250 in a center area of the dial 205. The activity object 250 is configured to provide controls for modifying events and adding events to the dial 205. In general, a region around the activity object is monitored by the gesture logic 130 for specific gestures that have been defined to correlate with particular inputs to the GUI 200. In this way, the GUI 200 is configured to include regions that are sensitive to gestures in order to provide an intuitive interaction for a user.

Additionally, the GUI 200 also includes a context panel 255 with a skip button 260 and a snooze button 265. Depending on a behavior/activity being tracked by the GUI 200, the context panel may display fewer or more buttons than the skip button 260 and the snooze button 265. Additionally, the context panel 255 may include different buttons for different functions associated with a current context of the GUI 200 such as adding different types of events, editing events in different ways and so on. In general, the context panel 255 is sensitive to a current condition of the GUI 200 (i.e., whether an event is due, overdue, and so on) and the interface logic 110 dynamically renders the context panel and changes available buttons and options that are rendered accordingly. In this way, the interface logic 110 manipulates which functions are available in relation to a current context of the GUI 200 and to maintain a single view of the GUI 200 without requiring additional menus to interact with the GUI 200.

Similarly, the gesture logic 130 is configured to monitor the GUI 200 for a gesture which is based on a current context. The gesture logic 130 receives and decodes input gestures from a user that interacts with the GUI 200 via the display 140. For example, the gesture logic 130 is configured to identify gestures from the user that include taps, swipes, drags, and/or combinations of these gestures on the display 140 as inputs to the GUI 200. The gesture logic 130 monitors for the gestures and a location of the gesture on the display 140 in order to determine an input to the GUI 200 in relation to elements that are currently rendered on the GUI 200 as defined by a current context of the GUI 200.

In one embodiment, the gesture logic 130 monitors for an input (i.e., gesture) to the GUI 200 via the display 140. In response to detecting the input, the gesture logic 130 determines characteristics of the gesture. The characteristics include a location of the gesture, a type of gesture (e.g., tap, swipe, drag, and so on), whether the gesture was initiated on a particular icon/button on the GUI 200, and so on. Additionally, the gesture logic 130 maintains awareness of the context (e.g., whether an event is due, which behavior is displayed) and translates the gesture as a function of the context to provide a context appropriate input. In this way, the gesture logic 130 receives and decodes input in order to determine a gesture of a user interacting with the GUI 200.

Additionally, In one embodiment, the gesture logic 130 uses a timer to resolve conflicting gestures in order to prevent accidental gestures by the user. That is, the gesture logic 130 starts a timer after receiving a first gesture and does not accept further gestures until the timer has elapsed. Accordingly, the gesture logic 130 prevents successive conflicting gestures. For example, consider that many different gestures that correlate with many different inputs are possible on the GUI 200. One example of a gesture is when a user swipes across the GUI 200 to switch to another screen with a different dial for a different behavior. Pagination indicator 270 indicates which screen is currently being viewed and also is a location that the gesture logic 130 monitors for the swipe gesture to switch screens.

However, when gesturing to switch screens the user may accidently swipe the dial 205 or tap a button on the context panel 255 that results in a different input than the swipe to switch screens. Accordingly, the gesture logic 130 initiates a timer upon detecting the swipe for switching screens so that any additional input received before the timer elapses that is not related to switching screens is not registered by the gesture logic 130. In this way, the gesture logic 130 resolves conflicting gestures and determines an intended input from the user without registering additional accidental gestures as actual inputs.

Furthermore, the gestures available as inputs depend on a current context of the GUI 200 and an associated behavior of the GUI 200. That is, depending on whether an event is presently due or whether the GUI 200 is tracking consumption versus logging activities in a schedule, the gesture logic 130 may resolve the same gestures as different inputs. That is, for example, when an event is due a gesture may log the event, whereas, when no event is due the gesture may add a new event to the dial 205. In general, the gesture logic 130 uses the gestures received through the GUI 200 to modify, log, or add an event from the dial 205.

For example, the gesture logic 130 is configured to detect several different gestures that include (1) tapping the activity object to respond to an alert that that an event is due or to add a new event at a current time, (2) dragging the activity object 250 to a button of the context panel 255 to modify an event (e.g., to snooze or skip), (3) dragging the activity object 250 to the dial 205 to add a new event onto the dial 205, (4) tapping an icon for an event to modify the event, (5) dragging an icon for an event to modify when the event occurred according to the dial 205, (6) tapping a button of the context panel 255 to modify a current event that is due, and so on.

Previous examples 1-6 are examples of how the gesture logic 130 may register gestures when the GUI 200 is tracking a schedule of behaviors such as medication doses. However, when the GUI 200 is a quantitative GUI that is tracking consumption of, for example, food or water the same gestures in examples 1-6 may register different inputs since the quantitative GUI has a different context. The inputs to the GUI 200 are registered, in part, as a function of the behavior (i.e., tracking mediation doses or tracking water consumption). Thus, for the quantitative GUI, gestures registered by the gesture logic 130 include, for example, tapping the GUI to log that an additional amount has been consumed (e.g., glass of water), dragging around a dial to indicate an amount that has been consumed, dragging around the dial to indicate a length of a sleep interval, and so on.

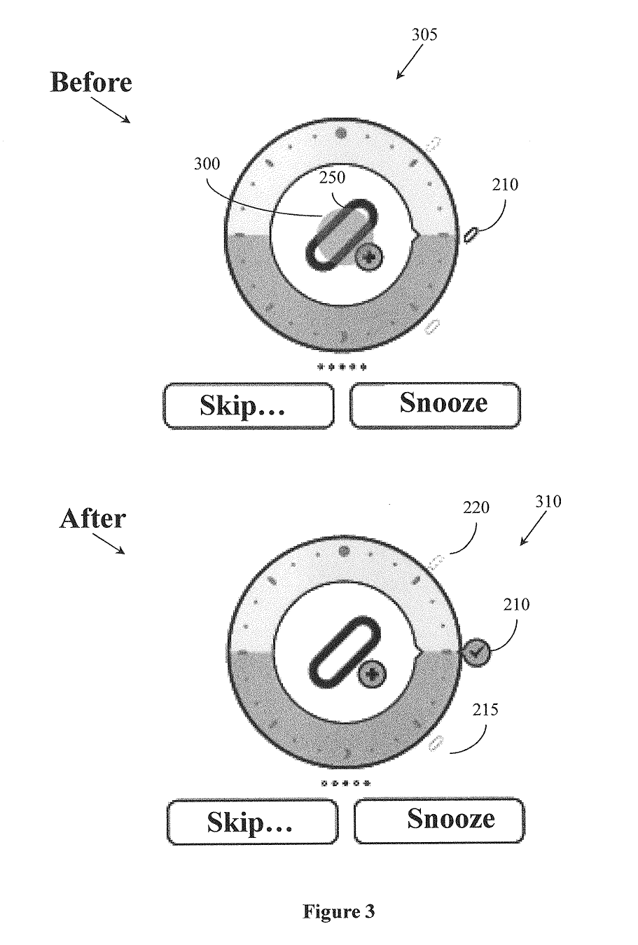

FIGS. 3-8 illustrate snapshots of the GUI 200 with different gestures and effects of the gestures. FIGS. 3-8 illustrate how the gestures are interpreted by the gesture logic 130 and then applied to a GUI by the interface logic 110 changing how the GUI 200 is subsequently rendered. For example, FIG. 3 illustrates a tap gesture 300 on the activity object 250 of the GUI 305. The gesture logic 130 detects the tap gesture 300 while monitoring for gestures. An action that is induced when tapping the activity object 250 depends on a current context of the GUI 305. For example, the gesture logic 130 is aware that the event 210 is presently due. Accordingly, a present context of the GUI 305 is focused on the event 210. Thus, when the gesture logic 130 identifies the tap gesture 300 the current event 210 is modified on the GUI 305 (as seen on GUI 310) as being logged or acknowledge. The GUI 310 illustrates how the interface logic 110 renders the GUI 310 after the event 210 has been logged from the tap gesture 300. In a different context, the tap gesture 300 induces a new event to be added to the dial 205. For example, when no event is presently due and the context reflects that no event is due, the tap gesture 300 adds a new event at the current time.

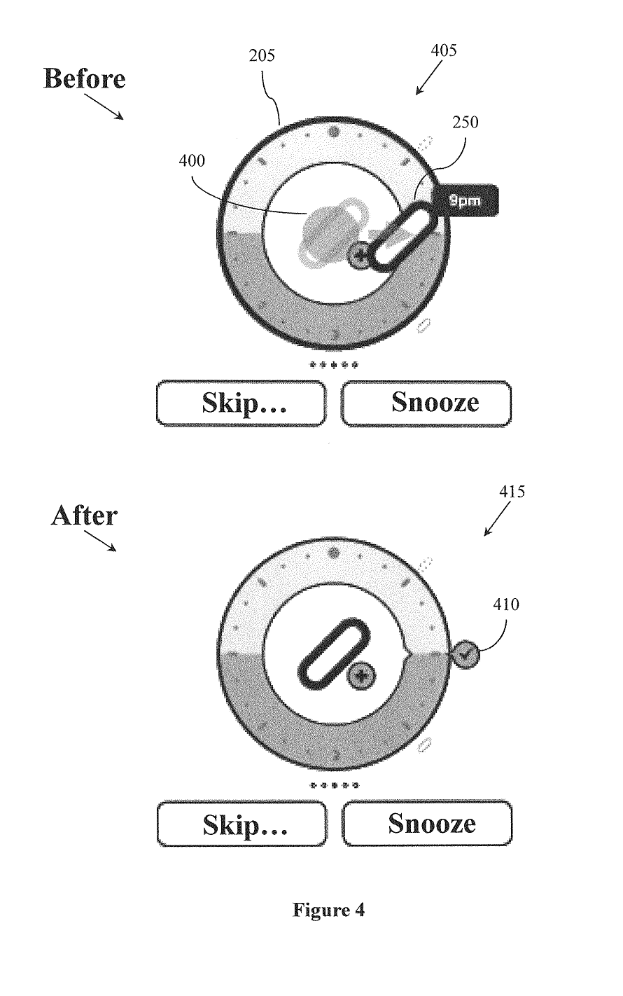

FIG. 4 illustrates a drag and drop gesture 400 with the activity object 250 being dragged onto the dial 205 at a particular location. The drag and drop gesture 400 adds a new event 410 to the dial 205 where the activity object 250 is dropped as seen in the GUI 415. In this way, a new event can be logged on the dial 205 while maintaining a context of the GUI 405 in a single view and not cluttering the GUI 405 with additional menus and screens for entering a new event.

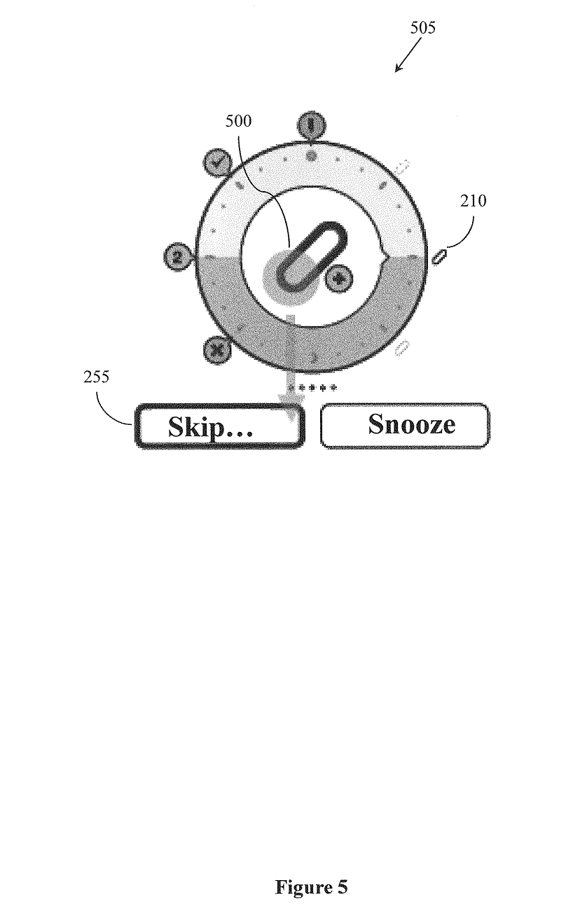

FIG. 5 illustrates a drag and drop gesture 500 from the GUI 505 to the skip button 255. The drag and drop gesture 500 is context sensitive. That is, because the event 210 is currently due, the gesture logic 130 applies the gesture 500 so that it modifies the event 210. In FIG. 5, the drag and drop gesture 500 modifies the event 210 by skipping the event 210 and not logging the event 210. Accordingly, an icon for the event 210 is changed into, for example, a pill with a dashed outline or a bubble with an “X” to indicate that the event 210 was skipped and not logged (not shown).

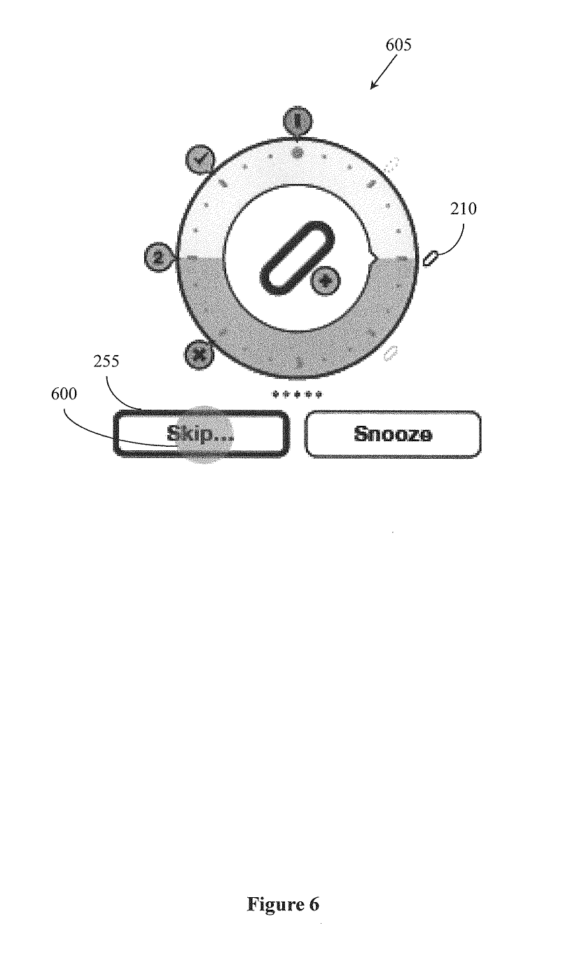

FIG. 6 illustrates another example of skipping the current event 210. Tap gesture 600 is a tap gesture to the skip button 255 which is registered by the gesture logic 130 to cause the event 210 to be skipped and not logged. Accordingly, an icon for the event 210 is changed into, for example, a pill with a dashed outline or a bubble with an “X” to indicate that the event 210 was skipped and not logged (not shown). Because a present context of the GUI 605 is focused on the current event 210, actions associated with tapping buttons of the context panel modify the current event 210.

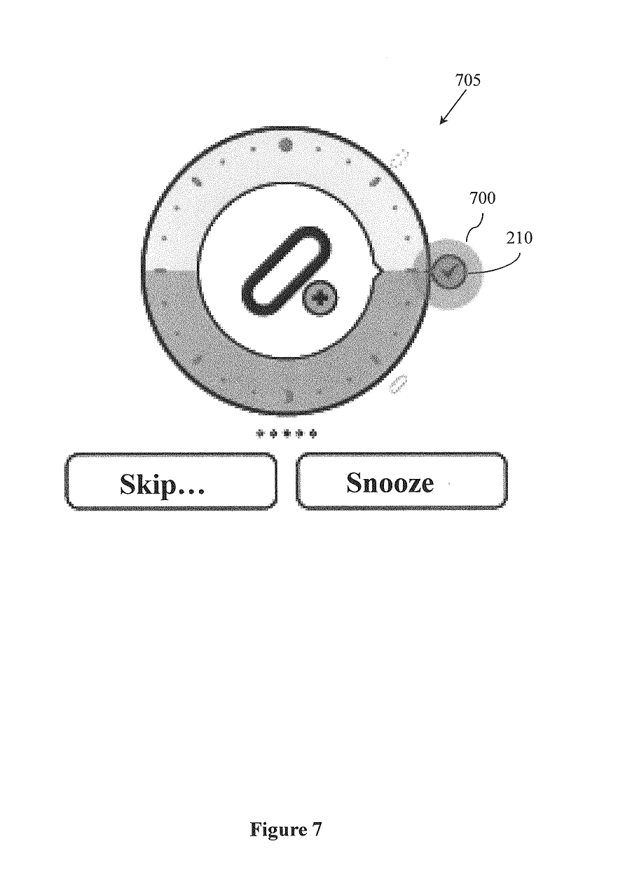

FIG. 7 illustrates an example of tapping an icon for an event (e.g., event 210). Tap gesture 700 is a tapping of the event 210 which causes details of the event 210, such as a time, an amount, and so on to be displayed for editing. In one embodiment, the details are edited by repeatedly tapping the event 210 or by tapping the event 210 and then dragging the event 210. In another embodiment, the tapping gesture 700 initiates an additional set of buttons to be displayed on GUI 705 for editing details associated with the event 210. In still a further embodiment, the tapping gesture 700 of an event (e.g., 210) on the GUI 705 causes an event detail GUI (not shown) to be displayed in place of the GUI 705. The event detail GUI may include additional options for editing the tapped event. In one embodiment, the additional options include options that are not commonly used, such as, modifying a dose amount, deleting an event, specifying particular information about a sleep event or side effect, and so on. In this way, for example, commonly used options may be displayed on the GUI 705 while less commonly used options are reserved for the event detail GUI.

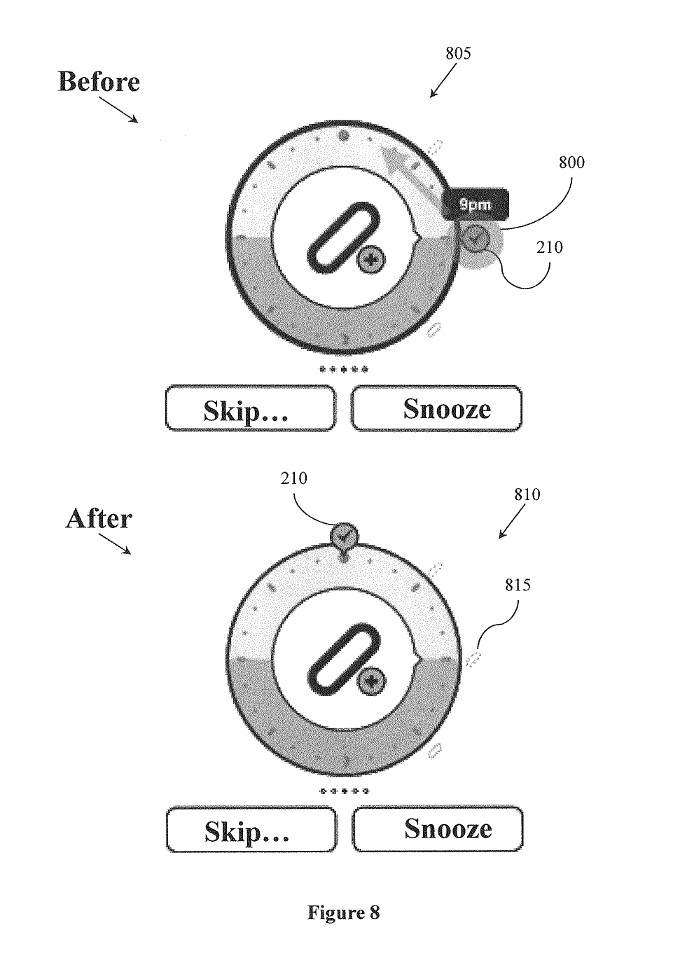

FIG. 8 illustrates a drag and drop gesture 800 of the event 210. In FIG. 8, GUI 805 shows the event 210 being dragged and dropped from an originally scheduled time of 9 pm to a new time at the top of the dial 205. GUI 810 shows a result of the drag and drop gesture 800 as rendered by the interface logic 110 of FIG. 1. In the GUI 810, a ghost icon 815 is located where the event 210 was originally scheduled and the event 210 is now displayed at the new time.

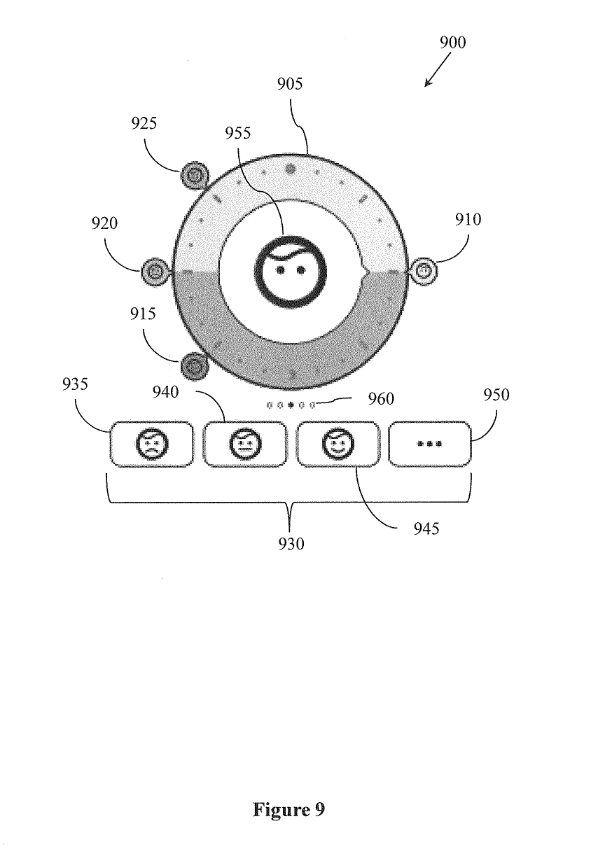

While tracking a schedule of medication doses has generally been described with FIGS. 2-8, of course, in another embodiment, the interface logic 110 generates graphical user interfaces for tracking and/or logging other behaviors. For example, with reference to FIG. 9, one example of a GUI 900 associated with tracking moods of a user is shown. The interface logic 110 generates the GUI 900 with a dial 905 that displays a schedule for a twenty-four hour period that defines a day. Events 910-925 are pinned around the dial 905 to correlate with a time when they have or will occur.

For example, the GUI 900 is used by a user to track and log their mood throughout a day. Accordingly, the GUI 900 is configured by the interface logic 110 and the schedule logic 120 with the events 910-925. In one embodiment, the schedule logic 120 sets reporting times around the dial 905 for when a user should report their current mood. In another embodiment, the schedule logic 120 does not set reporting times and a user simply logs a mood at their discretion. Still, in another embodiment, a combination of reporting times and discretionary logging by the user are implemented.

For example, the event 910 illustrates a reporting time for a mood as defined by the schedule logic 120. The event 910 is a reminder to the user to select a current mood from, for example, a context panel 930 that includes mood buttons 935-950 for logging different predefined moods to the dial 905. The buttons 935-945 are rendered by the interface logic 110 with pictographs that correlate with different moods. The interface logic 110 renders additional buttons on the context panel 930 when the button 950 is selected. The additional buttons may include additional moods and/or other editing options for events added to the dial 905. While the buttons 935-945 are illustrated with pictographs, of course, in other embodiments, the buttons 935-945 may be rendered with different images of with different colors that correlate with different moods.

Furthermore, the interface logic 110 renders the GUI 900 with an activity object 955 which functions similarly to the activity object 250 of FIG. 2. That is, in one embodiment, the activity object 955 is a region on the GUI 900 that registers particular functions when a user gestures over the activity object 955.

The GUI 900 also includes pagination indicators 960 to indicate a current position among many different screens that include different GUIs. In one embodiment, the device 100 of FIG. 1 renders the GUI 900 along with one or more versions of the GUI 200 that are each GUI displayed on a different screen. In this way, the device 100 provides GUIs to a user so that the user can track and log multiple different behaviors. For example, in addition to tracking/logging medication and moods, the device 100 provides GUIs for tracking sleep, exercise, food/water consumption and so on.

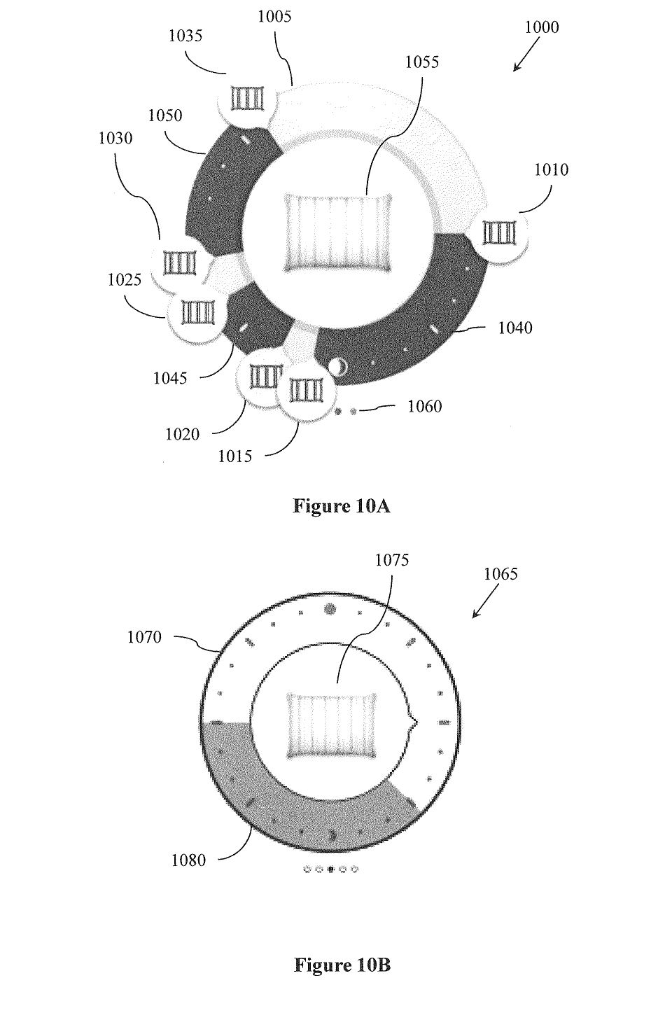

With reference to FIGS. 10A and 10B, examples of GUIs for tracking sleep are illustrated. In FIG. 10A, a GUI 1000 is generated by the interface logic 110 with a dial 1005 that correlates with a twenty four hour period of time. The dial 1005 permits a user to define beginning and end points 1010-1035 for sleep intervals 1040-1050 using gestures on the GUI 1000 that are interpreted by the gesture logic 130. An activity object 1055 displays a graphic icon for a sleep behavior and may also receive gestures to add or edit the points 1010-1035. A pagination indicator 1060 functions similarly to the pagination indicators 960 of FIG. 9.

FIG. 10B illustrates another embodiment of a GUI 1065 for tracking sleep behavior. The GUI 1065 includes a dial 1070 that displays a twenty four hour period of time. The dial 1070 includes a logged interval 1080 of sleep (e.g. the shaded area). However, the gesture logic 130 receives input on the GUI 1065 only through the activity object 1075 in the form of taps to start and end an interval (e.g., interval 1080) as opposed to input through the dial 1070 as in the case of the GUI 1000. Additionally, in one embodiment, the device 100 receives information for a sleep interval (e.g., interval 1080) that is logged automatically by a secondary device that is configured to track sleep or another activity that is being logged. Accordingly, the GUI 1065 may be updated according to logged data from the secondary device in addition to gestures received through the gesture logic 130.

In one embodiment, the GUI 1000 is controlled by the device 100 of FIG. 1 according to one or more predefined rules. The predefined rules include, for example, checks on inputs to ensure the inputs are within operating parameters, checks to ensure events do not conflict, checks to ensure accuracy of logged/tracked events, and son on. For example, the device 100 enforces the predefined rules to ensure that events and information about events logged into the GUI 1000 are accurate. That is, for instance, the gesture logic 130 is configured so that a user cannot change an end point (e.g., 1015, 1025, 1035) so that the end point is at a time in the future. In this way, the gesture logic 130 prevents a user from inaccurately logging an end time of a sleep interval since an end point that is logged at a point in the future is based on speculation and not fact.

Additionally, in one embodiment, the interface logic 110 newly renders the dial 1005 upon a time lapsing to a next twenty four hour interval. Accordingly, when a user views the GUI 1000 after the time lapses previously logged events are not shown. However, the gesture logic 130 is configured to interpret one or more gestures on the GUI 1000 that cause the interface logic 110 to switch to a previous twenty four hour period that includes the previously logged events. In this way, a user can switch between twenty four hour periods and log intervals that span twenty four hour periods. While the GUI 1000 is discussed in reference to predefined rules and switching between different views of periods of time, the GUI 200 and other GUIs discussed herein may be implemented with similar functionality.

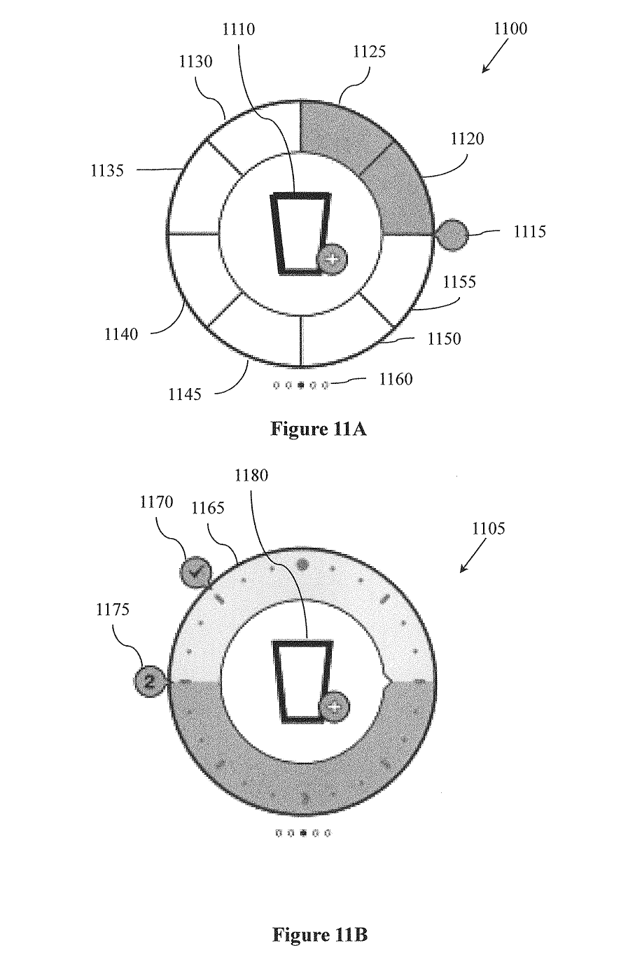

Additional examples of GUIs rendered by the device 100 are illustrated in FIGS. 11A and 11B. FIG. 11A shows a quantitative GUI 1100 and FIG. 11B shows a time GUI 1105. The GUI 1100 and the GUI 1105 illustrate different version of GUIs generated by the device 100 for tracking consumption of water and/or food. The device 100 generates the quantitative GUI 1100 in the form of an empty dial with subdivisions that correlate with portions. The subdivisions of the GUI 1100 are gradually filled as a user taps an activity object 1110. A start icon 1115 indicates a beginning point from which quantities 1120-1155 are gradually filled as a user consumes more water and logs the consumption by tapping the activity object 1110.

The gesture logic 130 detects taps of the activity object 1110 and consequently informs the interface logic 110 which renders a next quantity on the GUI 1100 as full (i.e., filled with a different color). The GUI 1100 is illustrated with two filled portions 1120-1125 that correlate with previously logged consumption. The GUI 1100 also illustrates unfilled portions 1130-1155 which correlate with consumption that is still required. In one embodiment, when all of the portions 1120-1155 are filled a goal for consuming water/food has been satisfied. The GUI 1100 also includes pagination indicators 1160 that functions similarly to the pagination indicators 960 of FIG. 9.

Additionally, in another embodiment, instead of taps or other gestures on the GUI 1100 as inputs, the device 100 receives input from a secondary device. For example, consider an embodiment of a quantitative GUI similar to the GUI 1100, but instead of tracking water consumption the GUI tracks exercise by logging a number of steps a person takes in a day. Accordingly, the device 100 is configured to receive input from a pedometer and log a number of steps taken by a user. Still in other embodiments, the secondary device may be a heart rate monitor, Electrocardiography (EKG), artificial pacemaker, or other device that provides input about an activity to the device 100 for use with the GUI. Additionally, the secondary device may also be used with a chronological GUI such as the GUI 1105 to track occurrences of different events (e.g., abnormal heart conditions, heart attacks, seizures, and so on).

The GUI 1105 illustrates a dial 1165 that indicates a period of time (e.g., 12 or 24 hours) within which a user is tracking consumption. The dial 1165 includes logged events 1170 and 1175 that correlate with two separate occurrences of consuming, for example, water. The event 1170 is represented by an icon with a check mark, which indicates consumption of a single portion. The event 1175 is represented by an icon with a number “2” within a bubble, which indicates consumption of two portions. In a similar manner, additional events may be logged on the dial 1165 that display numbers (e.g., 3, 4, 5, etc.) that correlate with consumption of larger quantities.

In one embodiment, the gesture logic 130 registers events for a current time indicated on the dial 1165 when, for example, a user taps an activity object 1180. The gesture logic 130 may register multiple portions when a user taps the activity object 1180 multiple times in series. Additionally, the device 100 modifies events on the dial 1165 in a similar manner as discussed previously with FIGS. 3-8.

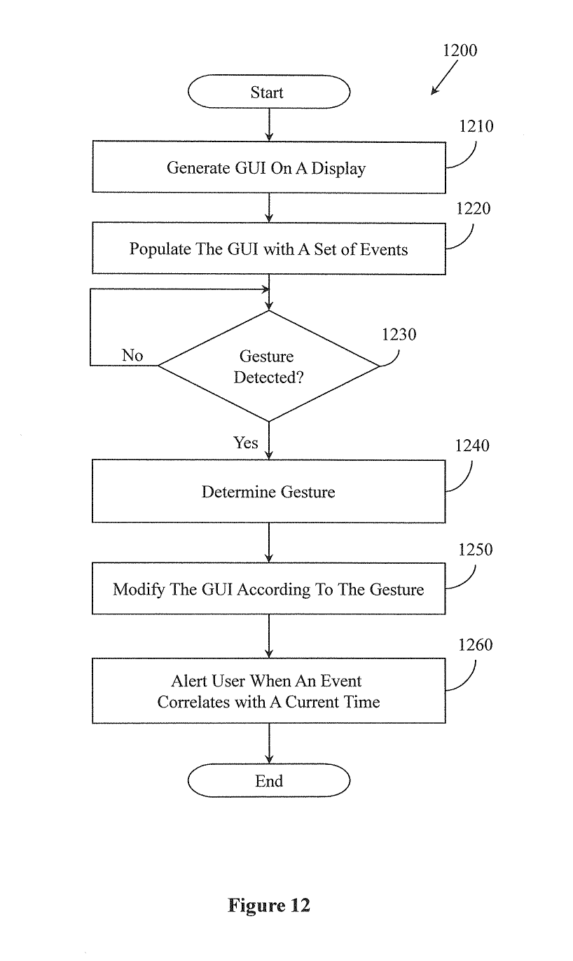

Further details of a user interface for tracking behaviors of a user will be discussed with reference to FIG. 12. FIG. 12 illustrates a method 1200 associated with generating and monitoring a graphical user interface (GUI) for tracking behaviors of a user. The method 1200 will be discussed from the perspective of a device that functions in accordance with method 1200. Accordingly, in general, the device includes at least a display for displaying the GUI and a processor for performing the method 1200.

At 1210, the device generates the GUI on a display. In one embodiment, generating the GUI includes rendering each portion of the GUI to provide context relevant information and functions for modifying the information. That is, the GUI is rendered to focus on a single behavior or activity within a single view of the display so that a user of the GUI can intuitively view and interact (e.g., modify, add, and so on) with the information without navigating multiple screens or menus. In this way, the GUI provides a context relevant view of the behavior/activity. In general, the behavior/activity is a medical behavior/activity of a user. Examples of behaviors and activities for which a GUI is used to log and track information include schedules of medication doses, consumption of food/water, exercise, sleep, moods, logging occurrences of medical conditions (e.g., seizures in both quantity and duration), and so on. While medical behaviors are discussed as the focus of the GUIs, of course, in other embodiments, GUIs are generated and used to track behaviors/activities that are not medical related (e.g., traffic counts, information about sporting events, lab testing details, and so on).

Furthermore, in general, the device generates the GUI with a dial, an activity object within a center region of the dial, and a context panel below the dial that includes at least one button. In one embodiment, the dial is a quantitative dial that includes subdivisions that indicate a number of portions to satisfy a goal. That is, the number of portions are, for example, a total goal for a period of time. For example, the number of portions are a number of glasses of water a user is to consume in a period of time, a number of meals a user is to consume in a period of time, a number of repetitions for an activity in a period of time, and so on. The period of time may be an hour, day, week, month, or other period of time that correlates with a duration of time for achieving the goal. Alternatively, a total for the activity/behavior can be logged without regard to a goal and thus the subdivisions on the dial that represent the number of portions may simply reset when filled.

In another embodiment, the dial includes indicators for a period of time (e.g., hours). That is, the dial displays a twelve hour clock, a twenty four hour clock, a seven day clock, and so on. Accordingly, the dial indicates a chronological order (i.e., schedule) for a set of events that are displayed on the dial. In general and as discussed further with respect to 1220 of method 1200, the device populates the dial with events that are predefined (e.g., scheduled medication doses and so on). However, the device generates the GUI with the activity object and the context panel so that the GUI is dynamic and capable of being modified on-the-fly as a user interacts with the GUI.

For example, the context panel, in combination with the activity object, are generated to provide functions to a user for interacting with and tracking the set of events. That is, the activity object and the context panel include buttons and/or interactive zones that permit a user to add, modify, and interact with the events and the GUI through gesture inputs. In this way, the device provides a single view of the GUI that is contextually relevant to a behavior being tracked.

Additionally, in one embodiment, the device generates the GUI with multiple dials that have associated activity objects and context panels that are each displayed on a separate screen. Each of the dials on a separate screen has a different context. That is, each of the dials is configured for a different activity/behavior that may include different buttons and other features for interacting with the dials. Additionally, the GUI is generated with page indicators on each screen that indicate which of the multiple dials a user is currently viewing and that also permit the user to switch between screens to interact with the different dials.

At 1220, the GUI is populated with a set of events. In one embodiment, the device populates the GUI with predefined events. That is, the device determines which events have been scheduled for a day and generates an icon on the dial of the GUI for each of the events. In one embodiment, the device imports the events from a calendar or other source where the events have previously been defined. In another embodiment, the events are manually entered into the GUI prior to the dial being rendered. That is, a setup screen or other form available through the GUI is used by the user to enter the events. Furthermore, the device is configured to add events to the dial according to an input of a user received through the GUI while the GUI is displaying the dial.

At 1230, the device monitors the display for gestures that are inputs to the GUI. The gestures are, for example, movements of a user's finger in relation to the display. That is, the user taps, swipes or performs combinations of these movements on the display when the GUI is displayed to form a gesture that is an input to the GUI. Accordingly, the display is monitored in relation to the GUI to detect when a gesture is being received.

If a gesture is detected, at 1230, then, at 1240, characteristics of the gesture are analyzed to determine the gesture. For example, the device interprets a gesture according to a location (e.g., start point and end point) of the gesture on the display in relation to elements (e.g., buttons, icons, the dial, etc.) that are displayed on the GUI. Accordingly, the device determines the characteristics (e.g., start point, end point, swipe, tap, location, etc.) in order to determine which gesture is intended as input by the user.

The gestures may include tapping the activity object to log that a new event is to be added to the set of events and to generate an icon for the new event on the dial at a location of a current time, tapping the activity object to respond to an alert that that an event from the set of events is due, dragging the activity object to a button of the context panel to modify an event, dragging the activity object to the dial to add a new event to the set of events, tapping an icon for an event on the dial to modify the event, dragging an icon for an event to modify when the event occurred according to the dial, tapping a button of the context panel to modify a current event that is due, tapping the dial or activity object to log a quantity, and so on.

Consequently, there are many possible gestures that are inputs to the GUI. The gestures provide the GUI with the ability to maintain a single view and context without cluttering the display with additional menus and screens, but can also result in conflicting gestures. That is, for example, when a user applies a gesture to the display as an input to the GUI, additional unintended gestures can be registered. As an example, consider a user tapping a button on the context panel. If the user also taps the activity object or brushes along the dial when tapping the button, then an incorrect gesture may end up being registered by the device.

Consequently, in one embodiment, the device is configured to resolve conflicting gestures. For example, the device may ignore additional taps/swipes after a beginning of an initial swipe, initiate a timer upon initiation of an initial gesture to only permit additional taps/swipes associated with the initial gesture for a predefined period of time, and so on. In this way, conflicting gestures are avoided and only intended gestures are registered as input to the GUI.

At 1250, the GUI is modified according to the gesture determined from block 1240. That is, in one embodiment, the device modifies the GUI to reflect input from the gesture. In this way, the gesture provides a context sensitive input to the GUI without using additional menus or screens.

At 1260, an icon on the GUI is changed to alert the user that an event correlates with a current time and is due. In one embodiment, an icon for the event changes color or changes a symbol displayed. Still in another embodiment, the device generates an audible alert to indicate to a user that the event is due. Additionally, in one embodiment, the GUI is altered to display details about the event when the alert is generated. The details include, for example, a medication name, a dose amount, instructions for taking a medication (e.g., with food, with water, etc.), and so on. In this way, the GUI facilitates tracking and logging behaviors/activities to support a user of the GUI.

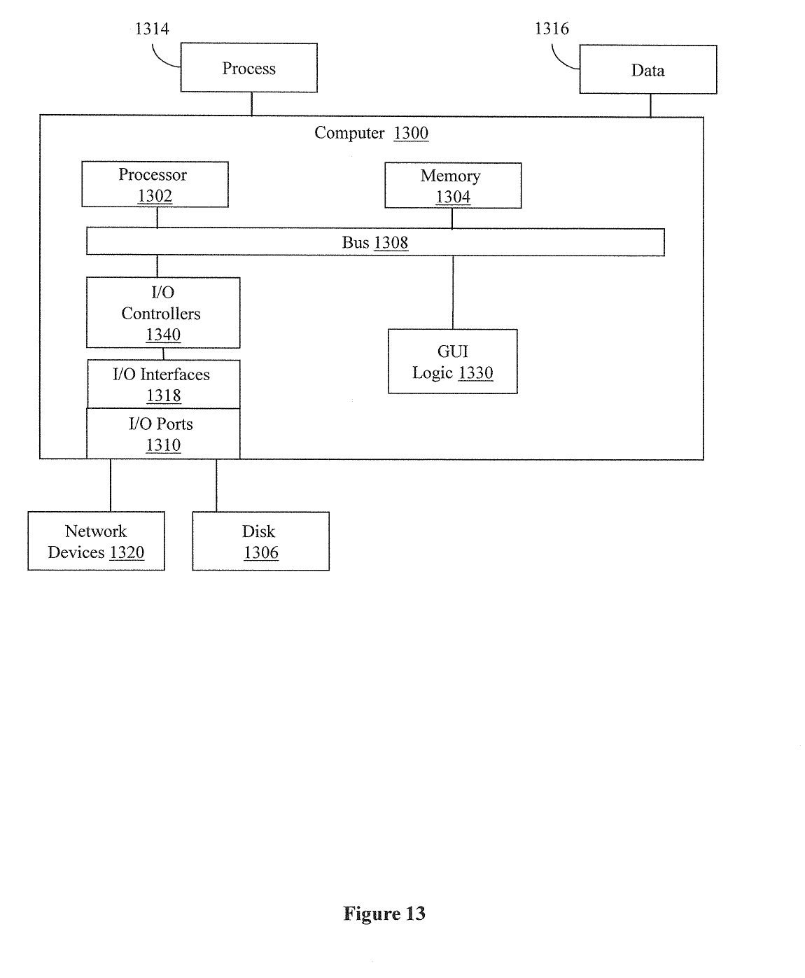

FIG. 13 illustrates an example computing device that is configured and/or programmed with one or more of the example systems and methods described herein, and/or equivalents. The example computing device may be a computer 1300 that includes a processor 1302, a memory 1304, and input/output ports 1310 operably connected by a bus 1308. In one example, the computer 1300 may include GUI logic 1330 configured to facilitate rendering and monitoring a graphical user interface similar to logics 110, 120, and 130 as shown in FIGS. 1, 2, and 3. In different examples, the logic 1330 may be implemented in hardware, a non-transitory computer-readable medium with stored instructions, firmware, and/or combinations thereof. While the logic 1330 is illustrated as a hardware component attached to the bus 1308, it is to be appreciated that in one example, the logic 1330 could be implemented in the processor 1302.

Generally describing an example configuration of the computer 1300, the processor 1302 may be a variety of various processors including dual microprocessor and other multi-processor architectures. A memory 1304 may include volatile memory and/or non-volatile memory. Non-volatile memory may include, for example, ROM, PROM, and so on. Volatile memory may include, for example, RAM, SRAM, DRAM, and so on.

A disk 1306 may be operably connected to the computer 1300 via, for example, an input/output interface (e.g., card, device) 1318 and an input/output port 1310. The disk 1306 may be, for example, a magnetic disk drive, a solid state disk drive, a floppy disk drive, a tape drive, a Zip drive, a flash memory card, a memory stick, and so on. Furthermore, the disk 1306 may be a CD-ROM drive, a CD-R drive, a CD-RW drive, a DVD ROM, and so on. The memory 1304 can store a process 1314 and/or a data 1316, for example. The disk 1306 and/or the memory 1304 can store an operating system that controls and allocates resources of the computer 1300.

The bus 1308 may be a single internal bus interconnect architecture and/or other bus or mesh architectures. While a single bus is illustrated, it is to be appreciated that the computer 1300 may communicate with various devices, logics, and peripherals using other busses (e.g., PCIE, 1394, USB, Ethernet). The bus 1308 can be types including, for example, a memory bus, a memory controller, a peripheral bus, an external bus, a crossbar switch, and/or a local bus.

The computer 1300 may interact with input/output devices via the i/o interfaces 1318 and the input/output ports 1310. Input/output devices may be, for example, a keyboard, a microphone, a pointing and selection device, cameras, video cards, displays, the disk 1306, the network devices 1320, and so on. The input/output ports 1310 may include, for example, serial ports, parallel ports, and USB ports.

The computer 1300 can operate in a network environment and thus may be connected to the network devices 1320 via the i/o interfaces 1318, and/or the i/o ports 1310. Through the network devices 1320, the computer 1300 may interact with a network. Through the network, the computer 1300 may be logically connected to remote computers. Networks with which the computer 1300 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read. Computer-readable medium described herein are limited to statutory subject matter under 35 U.S.C §101.

“Logic”, as used herein, includes a computer or electrical hardware component(s) of a computing device, firmware, a non-transitory computer readable medium that stores instructions, and/or combinations of these components configured to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions that when executed perform an algorithm, and so on. Logic may include one or more gates, combinations of gates, or other circuit components. Where multiple logics are described, it may be possible to incorporate the multiple logics into one physical logic component. Similarly, where a single logic unit is described, it may be possible to distribute that single logic unit between multiple physical logic components. Logic as described herein is limited to statutory subject matter under 35 U.S.C §101.

“User”, as used herein, includes but is not limited to one or more persons, computers or other devices, or combinations of these.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing computer-executable instructions that when executed by a computer cause the computer to perform a method, the method comprising:
generating, on a display of the computer, a graphical user interface (GUI) comprising:
a dial that indicates a chronological order for a set of events, wherein the dial includes a center area with an activity object for manipulating the set of events, and
a context panel that includes one or more buttons for modifying the set of events; and
populating, on the display of the computer, the dial with icons for the set of events by pinning the icons to the dial, wherein the set of events include predefined events for tracking behaviors of a user, and wherein populating the dial includes displaying the icons around the dial to correlate with when each of the set of events occurs.

2. The non-transitory computer-readable medium of claim 1, further comprising:
monitoring the GUI for a gesture from the user that is an input to modify an event from the set of events, wherein monitoring the GUI for the gesture includes determining the gesture by resolving one or more conflicting gestures; and
modifying, in response to the gesture, the GUI to reflect input from the gesture.

3. The non-transitory computer-readable medium of claim 2, wherein determining the gesture includes determining that the gesture includes:
tapping the activity object, dragging the activity object to a button of the context panel, dragging the activity object to the dial, tapping an icon for an event of the set of events, dragging an icon for an event, or tapping a button of the context panel.

4. The non-transitory computer-readable medium of claim 2, wherein the gesture provides a context sensitive input to the GUI without using additional menus or screens.

5. The non-transitory computer-readable medium of claim 1, wherein the dial displays a twenty four hour period that corresponds with a single day.

6. The non-transitory computer-readable medium of claim 1, wherein the set of events are medical events that include behaviors performed or to be performed by the user.

7. The non-transitory computer-readable medium of claim 6, wherein the set of events include medication doses.

8. The non-transitory computer-readable medium of claim 1, wherein generating the GUI includes generating the GUI to provide context relevant functions using the activity object and the context panel in a single display screen without using additional menus and display screens, and wherein the context relevant functions include functions associated with tracking the set of events.

9. The non-transitory computer-readable medium of claim 1, wherein generating the GUI includes generating multiple dials on separate screens for different behaviors of the user, wherein each of the multiple dials includes a different activity object and context panel for the different behaviors to track of the user.

10. The non-transitory computer-readable medium of claim 1, further comprising:
alerting the user that an event is due by changing an icon on the GUI when the event correlates with a current time, wherein the event is one of the set of events.

11. A system, comprising:
interface logic configured to generate, on a display of a device, a graphical user interface (GUI) comprising:
a dial that indicates a chronological order for a set of events, wherein the dial includes a center area with an activity object for manipulating the set of events, and
a context panel that includes one or more buttons for modifying the set of events on the dial; and
schedule logic configured to populate the dial with icons for the set of events by pinning the icons to the dial, wherein the set of events include predefined events for tracking behaviors of a user, and wherein the schedule logic is configured to populate the dial by displaying the icons around the dial to correlate with when each of the set of events occurs.

12. The system of claim 11, further comprising:
gesture logic configured to monitor the GUI for a gesture from the user that is an input to modify an event from the set of events, wherein the gesture logic is configured to monitor the GUI for the gesture by determining the gesture and resolving one or more conflicting gestures, wherein the interface logic is configured to modify, in response to the gesture, the GUI to reflect input from the gesture.

13. The system of claim 12, wherein the gesture logic is configured to determine the gesture by determining that the gesture includes:
tapping the activity object, dragging the activity object to a button of the context panel, dragging the activity object to the dial, tapping an icon for an event of the set of events, dragging an icon for an event, or tapping a button of the context panel.

14. The system of claim 11, wherein the gesture is a context sensitive input to the GUI that depends on a current state of the GUI and does not use additional menus or screens, wherein the interface logic is configured to generate the dial to display a twenty four hour period that corresponds with a single day, and wherein the set of events are medical events that include behaviors performed or to be performed by the user.

15. The system of claim 11, wherein the interface logic is configured to generate the GUI by generating the GUI to provide context relevant functions using the activity object and the context panel in a single display screen without using additional menus and display screens, and wherein the context relevant functions include functions associated with tracking the set of events.

16. The system of claim 11, wherein the interface logic is configured to generate the GUI by generating multiple dials on separate screens for different behaviors of the user, wherein each of the multiple dials includes a different activity object and context panel for the different behaviors to track of the user, and wherein each of the multiple screens include an independent context from other screens.

17. The system of claim 11, wherein the schedule logic is configured to alert the user that an event is due by changing an icon of the event on the GUI when the event correlates with a current time, and wherein the event is one of the set of events.

18. A computer-implemented method, the method comprising:
rendering, on a display of a computing device by at least a processor, a graphical user interface (GUI) comprising:
a dial for tracking behaviors, and
a set of buttons that provide functions for modifying a set of events on the dial, wherein the functions are contextually related to a health behavior that is tracked by a combination of the set of events and the dial;
detecting a gesture that is an input to the GUI from a user, wherein detecting the gesture permits context relevant input to control functions using the GUI in a single display screen without using additional menus and display screens, and wherein the context relevant functions include functions associated with tracking the set of events; and
modifying, in response to the gesture, the GUI to reflect input from the gesture.

19. The computer-implemented method of claim 18, wherein rendering the GUI includes rendering the dial as a quantitative dial that indicates a number of portions associated with a behavior of the user, and wherein the number of portions track consumption by the user.

20. The computer-implemented method of claim 19, wherein rendering the GUI includes rendering the dial with indicators for a period of time that correlates with a day, and wherein the dial displays a schedule for the set of events.
